(19) United States
(12) Patent Application Publication
(10) Pub. No.: US 2015/0356189 A1
(43) Pub. Date: Dec. 10, 2015

(54) Processing Sets of Objects and Determining Satisfaction Levels Thereof

(71) Applicant: Alibaba Group Holding Limited, Grand Cayman (KY)

(72) Inventors: Rue Zhang, Beijing (CN); Zhonglin Zu, Beijing (CN)

(21) Appl. No.: 14/728,602

(22) Filed: Jun. 2, 2015

(30) Foreign Application Priority Data
Jun. 5, 2014 (CN) 201410246705.1

(51) Int. Cl. G06F 17/30

(52) U.S. Cl. CPC G06F 17/30867; G06F 17/3053

(57) ABSTRACT

Methods and systems for processing sets of objects and determining satisfaction levels to the sets of objects. A computing device may rank multiple sets of objects based on an object satisfaction level of a user to an individual set of objects of the multiple sets of objects. The object satisfaction level may be obtained based on operation behavioral data of the user on the individual set of objects and operation behavioral data of the user on an object of the individual set of objects. The ranked sets of objects are consistent with historic operation behavior of the user to the multiple sets of objects. The implementations herein solve data exchange problems caused by repeated search operations and further decrease an amount of data exchange between a client terminal and the computing device, therefore reducing processing loads of the computing device.

### CROSS REFERENCE TO RELATED PATENT APPLICATIONS

This application claims priority to Chinese Patent Application No. 201410246705.1, filed on Jun. 5, 2014, entitled “Methods and systems for processing sets of objects and satisfaction levels thereof,” which is hereby incorporated by reference in its entirety.

### TECHNICAL FIELD

The present disclosure relates to search technologies, more particularly to methods and systems for processing multiple sets of objects and determining satisfaction levels thereof.

### BACKGROUND

With network development and the popularization of information technology, the Internet has gradually entered people's lives, study and work, and has brought mankind into the information age. However, due to a large amount of information available on the Internet, a user may have difficulty finding certain objects, such as goods or services. To improve the accuracy of searches, current techniques may define multiple objects having a same attribute as a group of objects. Therefore, a user may specify a query to target a certain group of objects. However, under these techniques, a search engine may render similar or the same search results for various queries since these results have a same or similar attribute associated with the queries. So the user has to repeat searches to further determine desired objects. This increases an amount of data exchange between client terminals (e.g., applications on the client terminal) and the search engine, resulting in an increase of processing loads on the search engine. In addition, these techniques do not calculate satisfaction levels of the user to multiple groups of objects.

### SUMMARY

Implementations of the present disclosure relate to methods and systems for processing sets of objects to reduce processing loads of the search engine and/or to improve the accuracy of determining users' satisfaction levels to multiple sets of objects. This Summary is not intended to identify all key features or essential features of the claimed subject matter, nor is it intended to be used alone as an aid in determining the scope of the claimed subject matter.

Implementations of the present disclosure relate to a method for processing multiple sets of objects. A search engine may acquire at least two sets of objects. The search engine may rank the at least two sets of objects based on an object satisfaction level of a user to an individual set of objects. The object satisfaction level may be obtained based on operation behavioral data of the user on the individual set of objects and operation behavioral data of the user on an object of the individual set of objects. The search engine may provide the ranked at least two sets of objects.

In implementations, the search engine may rank the at least two sets of objects based on an object satisfaction level of a user to an individual set of objects. In these instances, a scoring module associated with the search engine may acquire a first candidate satisfaction level of the user to the individual set of objects based on the operation behavioral data of the user on the individual set of objects. The scoring module may acquire a second candidate satisfaction level of the user to the individual set of objects based on the operation behavioral data of the user on the object of the individual set of objects and a mapping relationship between the multiple sets of objects and multiple of objects of the multiple of sets of objects. The scoring module may acquire an object satisfaction level based on the first candidate satisfaction level and the second candidate satisfaction level.

In implementations, to acquire a first candidate satisfaction level of the user to the individual set of objects based on the operation behavioral data of the user on the individual set of objects, the scoring module may acquire preference feature information of the user to the individual set of objects based on the operation behavioral data of the user on the set of objects. The scoring module may acquire the first candidate satisfaction level of the user to the individual set of objects based on attribute information of the individual set of objects and the preference feature information of the user to the individual set of objects.

In implementations, the scoring module may acquire a second candidate satisfaction level of the user to the individual set of objects based on the operation behavioral data of the user on the object of the individual set of objects and a mapping relationship between multiple sets of objects and multiple objects of the multiple sets of objects. For example, the scoring module may determine at least one object of the individual set of objects based on the mapping relationship, and then acquire a reference satisfaction level of the user to an individual object of the individual set of objects based on the operation behavioral data of the user on an object. The scoring module may acquire the second candidate satisfaction level of the individual set of objects based on multiple reference satisfaction levels of the user to objects of the individual set of objects.

In implementations, the scoring module may acquire at least one of operation behavioral data of the user on the set of objects, the mapping relationship, or the operation behavioral data of the user on an object from cookie information. In these instances, an object of the individual set of objects may include an item, the individual set of objects may be a standardized product unit, and the standardized product unit may include multiple items that have an attribute value.

Implementations of the present disclosure relate to a system for processing sets of objects. The system may include an acquiring module, a ranking module, an output module, and a scoring module. The acquiring module may acquire at least two sets of objects. The ranking module may rank the at least two sets of objects based on an object satisfaction level of a user to an individual set of objects. In these instances, the object satisfaction level may be obtained based on operation behavioral data of the user on the individual set of objects and operation behavioral data of the user on an object of the individual set of objects. The output module may provide the ranked at least two sets of objects.

The scoring module may acquire a first candidate satisfaction level of the user to the individual set of objects based on the operation behavioral data of the user on the individual set of objects, and may acquire a second candidate satisfaction level of the user to the individual set of objects based on the operation behavioral data of the user on the object of the individual set of objects and a mapping relationship between the multiple sets of objects and multiple of objects of the multiple of sets of objects.

In implementations, the scoring module may acquire an object satisfaction level based on the first candidate satisfaction level and the second candidate satisfaction level. The scoring module may acquire preference feature information of the user to the individual set of objects based on the operation behavioral data of the user on the set of objects. In these instances, the scoring module may acquire the first candidate satisfaction level of the user to the individual set of objects based on attribute information of the individual set of objects and the preference feature information of the user to the individual set of objects.

The scoring module may determine at least one object of the individual set of objects based on the mapping relationship, acquire a reference satisfaction level of the user to an individual object of the individual set of objects based on the operation behavioral data of the user on an object, and acquire the second candidate satisfaction level of the individual set of objects based on multiple reference satisfaction levels of the user to objects of the individual set of objects.

In implementations, the scoring module may acquire at least one of operation behavioral data of the user on the set of objects, the mapping relationship, or the operation behavioral data of the user on an object from cookie information.

In implementations, an object of the individual set of objects is an item, the individual set of objects is a standardized product unit, and the standardized product unit including multiple items having an attribute value.

Implementations of the present disclosure relate to a method for determining satisfaction levels of multiple sets of objects. In implementations, a scoring module may acquire a first candidate satisfaction level of the user to the individual set of objects based on the operation behavioral data of the user on the individual set of objects. The scoring module may further acquire a second candidate satisfaction level of the user to the individual set of objects based on the operation behavioral data of the user on the object of the individual set of objects and a mapping relationship between the multiple sets of objects and multiple of objects of the multiple of sets of objects. The scoring module may acquire an object satisfaction level based on the first candidate satisfaction level and the second candidate satisfaction level.

To acquire the first candidate satisfaction level of the user, the scoring module may acquire preference feature information of the user to the individual set of objects based on the operation behavioral data of the user on the set of objects, and acquire the first candidate satisfaction level of the user to the individual set of objects based on attribute information of the individual set of objects and the preference feature information of the user to the individual set of objects.

To acquire a second candidate satisfaction level of the user, the scoring module may determine at least one object of the individual set of objects based on the mapping relationship, acquire a reference satisfaction level of the user to an individual object of the individual set of objects based on the operation behavioral data of the user on an object, and acquire the second candidate satisfaction level of the individual set of objects based on multiple reference satisfaction levels of the user to objects of the individual set of objects.

In implementations, the scoring module may acquire at least one of operation behavioral data of the user on the set of objects, the mapping relationship, or the operation behavioral data of the user on an object from cookie information. In these instances, an object of the individual set of objects may be an item, the individual set of objects may be a standardized product unit, and the standardized product unit may include multiple items that have an attribute value.

Implementations of the present disclosure relate to a system for determining satisfaction levels of sets of objects. The system may include a first satisfaction level calculating module configured to acquire a first candidate satisfaction level of the user to the individual set of objects based on the operation behavioral data of the user on the individual set of objects. The system may further include a second satisfaction level calculating module configured to acquire a second candidate satisfaction level of the user to the individual set of objects based on the operation behavioral data of the user on the object of the individual set of objects and a mapping relationship between multiple sets of objects and multiple objects of the multiple sets of objects. The system may further include a third satisfaction level calculating module configured to acquire an object satisfaction level based on the first candidate satisfaction level and the second candidate satisfaction level.

The first satisfaction level calculating module may be configured to acquire preference feature information of the user to the individual set of objects based on the operation behavioral data of the user on the set of objects, and acquire the first candidate satisfaction level of the user to the individual set of objects based on attribute information of the individual set of objects and the preference feature information of the user to the individual set of objects.

The second satisfaction level calculating module may be configured to determine at least one object of the individual set of objects based on the mapping relationship, acquire a reference satisfaction level of the user to an individual object of the individual set of objects based on the operation behavioral data of the user on an object, and acquire the second candidate satisfaction level of the individual set of objects based on multiple reference satisfaction levels of the user to objects of the individual set of objects.

The system may further include a scoring module configured to acquire at least one of operation behavioral data of the user on the set of objects, the mapping relationship, or the operation behavioral data of the user on an object from cookie information.

In implementations, an object of the individual set of objects may be an item, the individual set of objects may be a standardized product unit, and the standardized product unit may include multiple items having an attribute value.

Implementations of the present disclosure include ranking, by a search engine, the at least two sets of objects based on an object satisfaction level of a user to an individual set of objects. The search engine may provide the ranked at least two sets of objects. Accordingly, the object satisfaction level may be obtained based on operation behavioral data of the user on the individual set of objects and operation behavioral data of the user on an object of the individual set of objects. The provided ranked at least two sets of objects may conform to historic operation behaviors of the user.

The implementations may solve data exchange problems caused by repeated search operations conducted by the user and the increase of data exchange between a local terminal and the search engine, therefore reducing the processing load of the search engine. In addition, the technical solution provided herein meets the individual needs of users, thereby increasing the targeted treatment of a set of objects.

In implementations, the object satisfaction level may be obtained based on operation behavioral data of the user on the individual set of objects and operation behavioral data of the user on an object of the individual set of objects. Accordingly, the object satisfaction level may be obtained more than merely the operation behavioral data of the user on the individual set of objects or merely operation behavioral data of the user on an object of the individual set of objects. This may effectively improve the accuracy of processing a set of objects.

The implementations of the present disclosure may acquire the mapping relationship between a set of objections and an object of the set of objects without searching a corresponding object based on an attribute of the set of objects. Therefore, the implementations of the present disclosure may effectively avoid extra overhead of searches.

Implementations of the present disclosure may include obtaining, by a scoring module, the object satisfaction level based on operation behavioral data of the user on the individual set of objects and operation behavioral data of the user on an object of the individual set of objects. In implementations, the object satisfaction level may be obtained more than merely the operation behavioral data of the user on the individual set of objects or merely operation behavioral data of the user on an object of the individual set of objects. This may improve the accuracy of measuring users' satisfaction levels to sets of objects.

The implementations of the present disclosure may acquire the mapping relationship between a set of objections and an object of the set of objects without searching a corresponding object based on an attribute of the set of objects. This may effectively avoid extra overhead of searches.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrative process for processing multiple sets of objects.

FIGS. 2 and 3 are schematic diagrams of illustrative computing architectures that enable processing multiple sets of objects.

FIG. 4 is a flow chart of an illustrative process for determining satisfaction levels of sets of objects.

FIGS. 5 and 6 are schematic diagrams of illustrative computing architectures that enable determining satisfaction levels of sets of objects.

### DETAILED DESCRIPTION

This present disclosure includes the following implementations and the accompanying drawings. Obviously, the described implementations of the present disclosure merely represent a part of the implementations of the present disclosure, and not all of the implementations. Based on the implementations in the present disclosure, other implementations made by those of ordinary skill in the art without creative efforts are within the scope of the present disclosure. In addition, the term “and/or” relationship is merely a description of the associated object; three relationships may exist. For example, A and/or B, may be expressed three conditions: A exists alone, B exists alone, or A and B exists. In addition, the character “/” generally indicates a “or” contextual relationship.

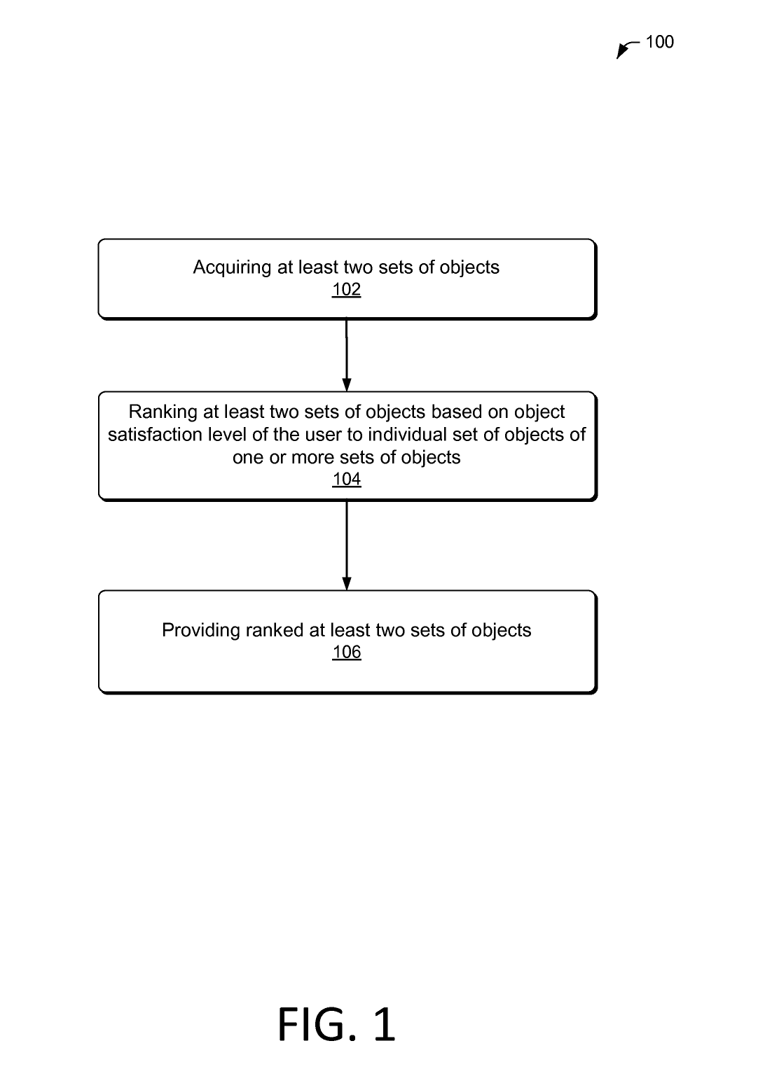

FIG. 1 is a flow chart of an illustrative process 100 for processing multiple sets of objects. In implementations, operations of the process 100 may be performed by the search engine associated with one or more servers. In implementations, the operations of the process 100 may be performed by a local client or a network terminal of a distributed system. It is understood that the local client may be a local terminal installed on the terminal or client (nativeApp) or a web browser program (webApp) terminal. The present disclosure is not particularly limited to this as long as the search engine may search sets of objects and/or recommend search results objective.

At 102, a search engine may acquire at least two sets of objects. In implementations, the search engine may search a database based on a keyword in a query entered by the user, and provide the ranked at least two sets of objects as search results for the user. For convenience of description, the current user in the subsequent description of implementations of the present implementations refers to the user.

In implementations, the search engine may search the database based on characteristic information of the user, and provide the ranked at least two sets of objects as search results for the user. The search engine may acquire at least two sets of objects using various methods. The present disclosure is not particularly limited to this.

At 104, the search engine may rank the at least two sets of objects based on an object satisfaction level of a user to an individual set of objects. The object satisfaction level may be obtained based on operation behavioral data of the user on the individual set of objects (also referred to as “first operation behavioral data”) and operation behavioral data of the user on an object of the individual set of objects (also referred to as “second operation behavioral data”). In implementations, the object satisfaction level may be obtained based on operation behavioral data of multiple users associated with the user.

In implementations, a scoring module may further acquire a first candidate satisfaction level of the user to the individual set of objects based on the operation behavioral data of the user on the individual set of objects, and acquire a second candidate satisfaction level of the user to the individual set of objects based on the operation behavioral data of the user on the object of the individual set of objects and a mapping relationship between multiple sets of objects and multiple objects of the multiple sets of objects. Then, the scoring module may acquire an object satisfaction level based on the first candidate satisfaction level and the second candidate satisfaction level.

The operation behavioral data of the user on the set of objects of the user may include operation behavioral data of the user on objects of one or all portions of sets of objects of websites associated with the search engine. In implementations, the operation behavioral data of the user on the set of objects may include operation behavioral data of the user on sets of objects to be ranked. The present disclosure is not particularly limited to this.

In implementations, the operation behavioral data of the user on the set of objects may include search information, browse information and click-through information. The present disclosure is not particularly limited to this.

The operation behavioral data of the user on the object may include the operation behavioral data of the user on objects of one or all portions objects of websites associated with the search engine, or the operation behavioral data of the user on objects to be ranked. The present disclosure is not particularly limited to this.

In implementations, the operation behavioral data of the user on an object may include searching information, clicking through information, bookmarking information, ordering information, and/or purchasing information. The present disclosure is not particularly limited to this.

In embodiments, the scoring module may further acquire at least one of operation behavioral data of the user on the set of objects, the mapping relationship, or the operation behavioral data of the user on an object from cookie information.

Cookie, sometimes also used in the plural form of Cookies, refers to certain data (usually encrypted) used by certain websites to identify or track a user identity and/or a session (Session). The cookie may be stored on a client terminal. Specifically, these sites may assign a unique identification Cookie (CookieID) for the client terminal to create a Cookie object on the client terminal. Accordingly, operation behavioral data of the user on an object may be stored on the client terminal to form Cookie information.

Cookie information may be used to track site statistics, which may indicate habits of users associated with accessing the site. For example, accessing times, visited pages, a time that a user spends on the site, an action taken by the user when visiting the site, and so on. A computing device may retrieve the Cookie information using various methods. For example, on a page of the website, the computing device may place a 1×1 invisible pixel. When a user first visits the page, the computing device may get a site for the user and assign a unique identification Cookie (CookieID) to the user.

The computing device may create a Cookie object on the client terminal. Accordingly, the computing device may store operation behavioral data of the user on the client terminal to form Cookie information. Thus, the client terminal may transmit the Cookie information and specify timing information in the Cookie sent to the site. For example, the client terminal may transmit the Cookie to the website when the client terminal requests to revisit the website.

In implementations, the Cookie information may include at least one of CookieID, a user identify of a user, operation behavioral data of the user on the individual set of objects, operation behavioral data of the user on an object of the individual set of objects, and a mapping relationship between an object and the set of objects. The present disclosure is not particularly limited to this.

The user identify information may include a user identify (ID) or an IP address of the client terminal. The present disclosure is not particularly limited to this.

The mapping relationship between a set of objects and an object of the set of objects may indicate an operation that a user receives a search result of the object and clicks the object. Then, this operation may be recorded to indicate the mapping relationship between the set of objects and the object of the set of objects. For example, the scoring module may acquire a first candidate satisfaction level of the user to an individual set of objects based on the operation behavioral data of the user on the individual set of objects of at least two sets of objects. The operation behavioral data of the user may include operations the user performs on the individual set of objects of the at least two sets of objects.

In implementations, the operation behavioral data of the user on the set of objects of the user may include operation behavioral data of the user on objects of one or all portions of sets of objects listed on one or more websites associated with the search engine and/or a service provider.

The scoring module may acquire preference feature information of the user to the individual set of objects based on the operation behavioral data of the user on the set of objects. Then, the scoring module may acquire a first candidate satisfaction level of the user to the individual set of objects based on reference feature information of the user to the individual set of objects.

In implementations, the scoring module may acquire the first candidate satisfaction level of the user to the individual set of objects based on the mapping between attribute information of the individual set of objects and the preference feature information of the user to the individual set of objects. For example, a successful matching may indicate a high satisfaction level of the user to a set objects. An unsuccessful matching may indicate a low satisfaction level of the user to the set of object. A matching algorithm for processing feature information may include various matching algorithms, such as a Euclidean distance algorithm.

Use of preference feature information of a set of objects makes the coverage of the set of objects more extensive, therefore effectively improving the accuracy of processing the set of objects.

In implementations, the scoring module may determine at least one object of the individual set of objects based on the mapping relationship. Then, the scoring module may acquire a first candidate satisfaction level of the user to the individual set of objects based on the operation behavioral data of the user on the individual set of objects, which may include operations the user performs on the individual set of objects of the at least two sets of objects. In this way, the scoring module may acquire the second candidate satisfaction level of the individual set of objects based on multiple reference satisfaction levels of the user to objects of the individual set of objects. For example, the scoring module may acquire the second candidate satisfaction level of the individual set of objects based on an average value of multiple reference satisfaction levels of the user to objects of the individual set of objects.

In implementations, the scoring module may determine at least one object of the individual set of objects based on the mapping relationship. Then, the scoring module may acquire preference feature information of the user to the individual set of objects based on the operation behavioral data of the user on the set of objects, which may include operation data on all the objects of one or more websites associated with the scoring module and/or a service provider.

The scoring module may acquire the first candidate satisfaction level of the user to the individual set of objects based on attribute information of the individual set of objects and the preference feature information of the user to the individual set of objects. The scoring module may acquire the second candidate satisfaction level of the individual set of objects based on multiple reference satisfaction levels of the user to objects of the individual set of objects.

A matching algorithm for processing feature information may include various matching algorithms, such as a Euclidean distance algorithm.

Use of preference feature information of a set of objects makes the coverage of the set of objects more extensive, therefore effectively improving the accuracy of processing the set of objects.

The scoring module may acquire an object satisfaction level based on the first candidate satisfaction level, a weight factor associated with the first candidate satisfaction level, the second candidate satisfaction level, and a weight factor associated with the second candidate satisfaction level.

The scoring module may obtain the object satisfaction level using the following equation:

$$H ( {s}_{SPUId} ) = ( 1 - α ) [ \frac{{\sum }_{offerId} f ( {x}_{offerId} )}{{N}_{s}} ] + α G ( {s}_{SPUId} )$$

wherein:

SPUId represents an ID of a set of objects;

H(s_{SPUId}) represents the object satisfaction level of the user to a set of objects SPUId,

α represents a weight factor of the first candidate satisfaction level,

G(s_{SPUId}) represents the first candidate satisfaction level,

1−α represents a weight factor of the second candidate satisfaction level,

offerId represents an ID identified an object of the set of objects SPUId,

x_{offerId} represents the operation behavioral data on the identified object offerId of the identified set of objects SPUId,

f(x_{offerId}) represents the reference satisfaction level of the user to the identified object offerId of the identified set of objects SPUId,

Nₛ represents a number of objects of the identified set of objects SPUId,

$$\frac{{\sum }_{offerId} f ( {x}_{offerId} )}{{N}_{s}}$$

represents the second candidate stratification level, an average of multiple reference satisfaction levels of the user to each identified object of the identified set of objects SPUId.

The search engine may rank the at least two sets of objects based on an object satisfaction level of the user to an individual set of objects. In implementations, the search engine may rank sets of objects using various techniques. For example, a matching algorithm may be implemented to measure a matching degree between a keyword and the set of objects. The search engine may assign a weight factor to a ranking parameter to obtain a ranking fraction and to rank each object.

In implementations, the object may be an item. Multiple items having one or more same attribute may be defined or classified as a standardized product unit (SPU), also called a product having the same category. Using SPU, a specific item may be easily located by navigating through one or more clickable SPU tags. In these instances, SPU may be reused for classification of new item or commodity to be sold by a merchant on an e-commerce platform. Typically, one SPU correspond to multiple items or commodities, while an item or a commodity corresponds to only one SPU.

In a shopping website of Alibaba China (http://www.1688.com/), and a SPU may be defined to include high density polyethylene (HDPE) having the same type number and/or being made in the same place, such as SPU1, SPU2, . . . , SPUₙ (n is an integer greater than one). SPU1 may be referred as a first set of objects, and SPU2 may be referred as a second set of objects.

A user may use a browser to access Alibaba China website (http://www.1688.com/), and then enter a query keyword “HDPE 5000S” in the search input box. The browser transmits the query keyword “HDPE 5000S” to a search engines associated with the Alibaba China website. After the search engine receives the query keyword “HDPE 5000S”, the search engine may obtain multiple SPU products corresponding to “HDPE 5000S” in the database based on the query. The search engine may provide the SPU products as search results to the user, such as HDPE/Daqing Petrochemical/5000S, HDPE/Yangzi Petrochemical/5000S, HDPE/Lanzhou Petrochemical/5000S, HDPE/Yanshan Petrochemical/5000S, HDPE/Honam/5000S products. For example, HDPE/Daqing Petrochemical/5000S may be the first set of objects, and HDPE/Yangzi Petrochemical/5000S may be the second set of objects.

Then the scoring module may read Cookie information stored on the client terminal. The Cookie information may include data of user ID information, operation behavioral data of the user to the SPU, a mapping relationship between the SPU and the item, and operation behavioral data of the user to the item. Then the scoring module may acquire preference feature information of the user to the SPU based on the operation behavioral data on the SPU, which may include operation data on all SPUs associated with Alibaba. For example, the operation data may include SPU key attributes information of user preferences, SPU market information of user preferences, and/or SPU geographical information of user preferences.

In implementations, the scoring module may further read the Cookie information to obtain the operation behavioral data on the SPUs, which may include operation data on all SPUs associated with Alibaba. The scoring module may further obtain preference feature information of the user to SPUs based on the operation behavioral data on the SPUs. The present disclosure is not particularly limited to this. Then the scoring module may acquire the first candidate satisfaction level of the user to an individual SPU based on the mapping between attribute information of the individual SPU and the preference feature information of the user to the individual SPU, which may include SPU key attributes information of the user preference, SPU market information of user preferences, and/or SPU geographical information of user preferences. For example, a successful matching may indicate a high satisfaction level of the user to the SPU, while an unsuccessful matching may indicate a low satisfaction level of the user to the SPU.

The scoring module may determine at least one object of the individual SPU based on the mapping relationship, and acquire a reference satisfaction level to an individual item based on the operation behavioral data of the user to the individual item.

In implementations, the scoring module may further acquire the operation behavioral data of the user to the individual item based on the Cookie information stored on the client terminal, and acquire a reference satisfaction level to an individual item based on the operation behavioral data of the user to the individual item. The present disclosure is not particularly limited to this.

The scoring module may acquire the second candidate satisfaction level of the individual SPU based on an average value of multiple reference satisfaction levels of the user to objects of the individual SPU. Then, the scoring module may acquire an object satisfaction level of the user to the individual SPU based on the first candidate satisfaction level, a weight factor associated with the first candidate satisfaction level, the second candidate satisfaction level, and a weight factor associated with the second candidate satisfaction level. In implementations, a search engine may rank SPUs in search results based on the SPU object satisfaction level of the user to the individual SPU of the SPUs in the search results.

At 106, the search engine may provide the ranked at least two sets of objects. For example, the search engine may output 6 sets of objects including set of objects 1, set of objects 2, set of objects 3, set of objects 4, set of objects 5, and set of objects 6. The search engine may rank these six sets of objects based on an object satisfaction level of each set of objects in a descending order.

Suppose that the object satisfaction level of set of objects 3>the object satisfaction level of set of objects 2>the object satisfaction level of set of objects 5>the object satisfaction level of set of objects 1>the object satisfaction level of set of objects 4>the object satisfaction level of set of objects 6. After ranking, the search engine may provide the search results as follow: set of objects 3, set of objects 2, set of objects 5, set of objects 1, set of objects 4, and set of objects 6.

Implementations of the present disclosure may output at least two sets of objects, provide recommendation and guidance to the user, and help the user to fine the object timely. In implementations, the operation behavioral data on an object may be defined based on various needs. For example, the user may need guidance for various operations including ordering, selecting, advertising, and/or purchasing items. In instances, the operation behavioral data on an object may be associated with purchasing information of the object associated with the user and/or other users.

In implementations, as for potential users, the operation behavioral data on an object may be associated with storing and/or bookmarking information of the object.

In implementations, if the user needs guidance of improvement on an object, the operation behavioral data on an object may be collected to be associated with click-through information of the object. The present disclosure is not particularly limited to this.

Implementations of the present disclosure may include ranking, by a search engine, at least two sets of objects based on an object satisfaction level of a user to an individual set of objects. The search engine may provide the ranked at least two sets of objects. The object satisfaction level may be obtained based on operation behavioral data on the individual set of objects and operation behavioral data of the user on an object of the individual set of objects. The outputted sets of objects are consistent with historic operation behavior of the user to sets of objects.

The implementations may solve data exchange problems caused by repeated search operations conducted by the user and further decrease data exchange between a local terminal and the search engine. This may reduce processing loads of the search engine. In addition, the technical solution provided meets the individual needs of users and increases accuracy of searches. In addition, the object satisfaction level may be obtained based on operation behavioral data on the individual set of objects and operation behavioral data on an object of the individual set of objects.

In implementations, the object satisfaction level may be obtained more than merely the operation behavioral data on the individual set of objects or merely operation behavioral data on an object of the individual set of objects. This may effectively improve the accuracy of processing a set of objects.

In implementations, the implementations of the present disclosure may acquire the mapping relationship between a set of objections and an object of the set of objects without searching a corresponding object based on an attribute of the set of objects. This may effectively avoid extra overhead of searches.

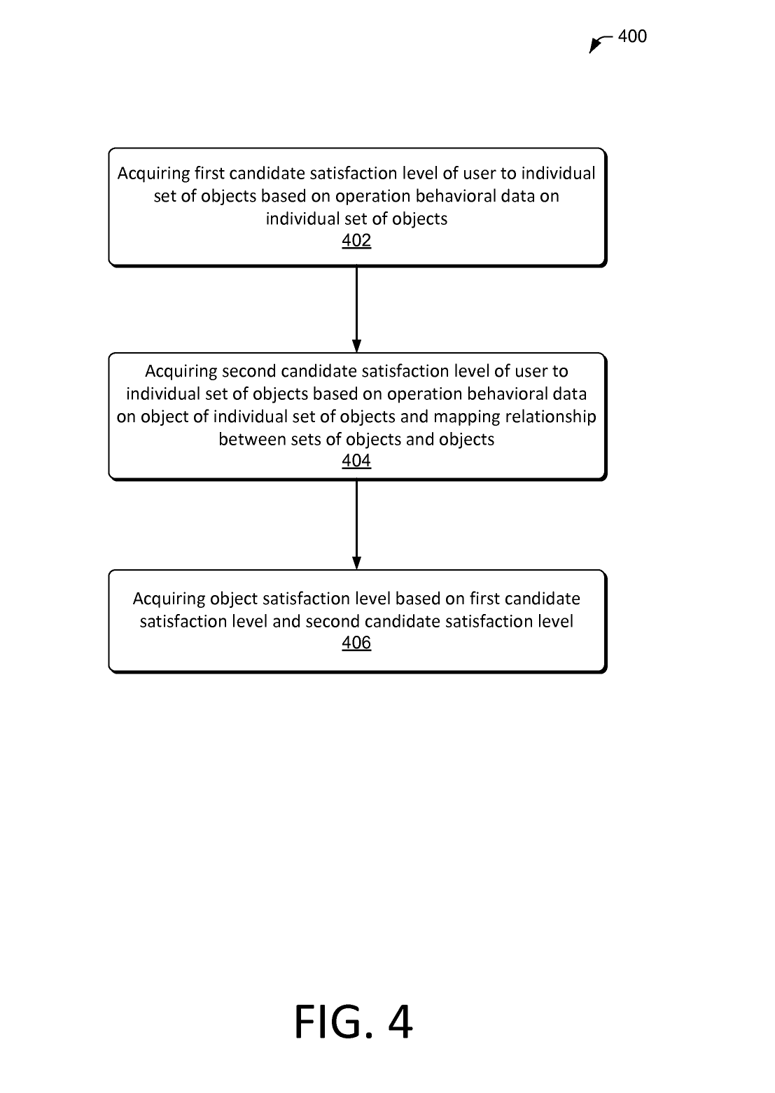

FIG. 4 is a flow chart of an illustrative process 400 for determining satisfaction levels of multiple sets of objects. In implementations, operations may be performed by the search engine associated with one or more servers. In implementations, the operations may be performed by a local client or a network terminal of a distributed system. For example, it is understood that the local client may be a local terminal installed on the terminal or client (nativeApp), or a web browser program (webApp) terminal. The present disclosure is not particularly limited to this as long as the search engine may search sets of objects and/or recommend search results objective.

At 402, a scoring module may acquire a first candidate satisfaction level of the user to the individual set of objects based on the operation behavioral data on the individual set of objects.

At 404, the scoring module may acquire a second candidate satisfaction level of the user to the individual set of objects based on the operation behavioral data on the object of the individual set of objects and a mapping relationship between multiple sets of objects and multiple objects of the multiple sets of objects.

At 406, the scoring module may acquire an object satisfaction level based on the first candidate satisfaction level and the second candidate satisfaction level.

In implementations, the scoring module may acquire preference feature information of the user to the individual set of objects based on the operation behavioral data on the set of objects. Then, the scoring module may acquire a first candidate satisfaction level of the user to the individual set of objects based on reference feature information of the user to the individual set of objects.

In implementations, the scoring module may acquire the first candidate satisfaction level of the user to the individual set of objects based on the mapping between attribute information of the individual set of objects and the preference feature information of the user to the individual set of objects. For example, a successful matching may indicate a high satisfaction level of the user to a set objects, while an unsuccessful matching may indicate a low satisfaction level of the user to the set of object.

A matching algorithm for processing feature information may include various matching algorithms, such as a Euclidean distance algorithm. Use of preference feature information of a set of objects makes the coverage of the set of objects more extensive, therefore, effectively improving the accuracy of processing the set of objects.

In implementations, the scoring module may determine at least one object of the individual set of objects based on the mapping relationship. The scoring module may acquire a reference satisfaction level of the user to an individual object of the individual set of objects based on the operation behavioral data on an object. The scoring module may acquire the second candidate satisfaction level of the individual set of objects based on multiple reference satisfaction levels of the user to objects of the individual set of objects. In implementations, the scoring module may acquire the second candidate satisfaction level of the individual set of objects based on an average value of the multiple reference satisfaction levels of the user to objects of the individual set of objects.

In implementations, the scoring module may acquire at least one of operation behavioral data on the set of objects, the mapping relationship, or the operation behavioral data on an object from cookie information. Accordingly, the scoring module may acquire an object satisfaction level based on the first candidate satisfaction level, a weight factor associated with the first candidate satisfaction level, the second candidate satisfaction level, and a weight factor associated with the second candidate satisfaction level.

The scoring module may obtain the object satisfaction level using the following equation:

$$H ( {s}_{SPUId} ) = ( 1 - α ) [ \frac{{\sum }_{offerId} f ( {x}_{offerId} )}{{N}_{s}} ] + α G ( {s}_{SPUId} )$$

Wherein:

SPUId represents to an ID of a set of objects,

H(s_{SPUId}) represents to the object satisfaction level of the user to a set of objects SPUId,

α represents a weight factor of the first candidate satisfaction level,

G(s_{SPUId}) represents the first candidate satisfaction level,

1−α represents a weight factor of the second candidate satisfaction level,

offerId represents an ID identified an object of the set of objects SPUId,

x_{offerId} represents the operation behavioral data on the identified object offerId of the identified set of objects SPUId,

f(x_{offerId}) represents the reference satisfaction level of the user to the identified object offerId of the identified set of objects SPUId,

Nₛ represents a number of objects of the identified set of objects SPUId,

$$\frac{{\sum }_{offerId} f ( {x}_{offerId} )}{{N}_{s}}$$

represents an average of the second satisfaction levels of the user to each identified object of the identified set of objects SPUId.

In implementations, the scoring module may further acquire at least one of operation behavioral data on the set of objects, the mapping relationship, or the operation behavioral data on an object from cookie information.

Detailed descriptions may be found in corresponding implementations of FIG. 1. The relevant contents of steps performed by the scoring module may not be mentioned here. The scoring module may obtain the object satisfaction level based on operation behavioral data on the individual set of objects and operation behavioral data on an individual object of the individual set of objects. Accordingly, the object satisfaction level may be obtained more than merely the operation behavioral data on the individual set of objects or merely operation behavioral data on an object of the individual set of objects. This may improve the accuracy of measuring users' satisfaction levels to multiple sets of objects.

In addition, the implementations of the present disclosure may acquire the mapping relationship between a set of objections and an object of the set of objects without searching a corresponding object based on an attribute of the set of objects. Therefore, these implementations may effectively avoid extra overhead of searches.

It should be noted that, for a simple description, operations may be described as a series of steps. Those skilled in the art should be aware; this present disclosure is not limited to the described order of operations. Certain operations may be performed in other orders or simultaneously. Certain operations may not be necessary for implementations of the present disclosure. In the above implementations, the various implementations described are different emphases; a certain portion of implementations may be found in other described implementations.

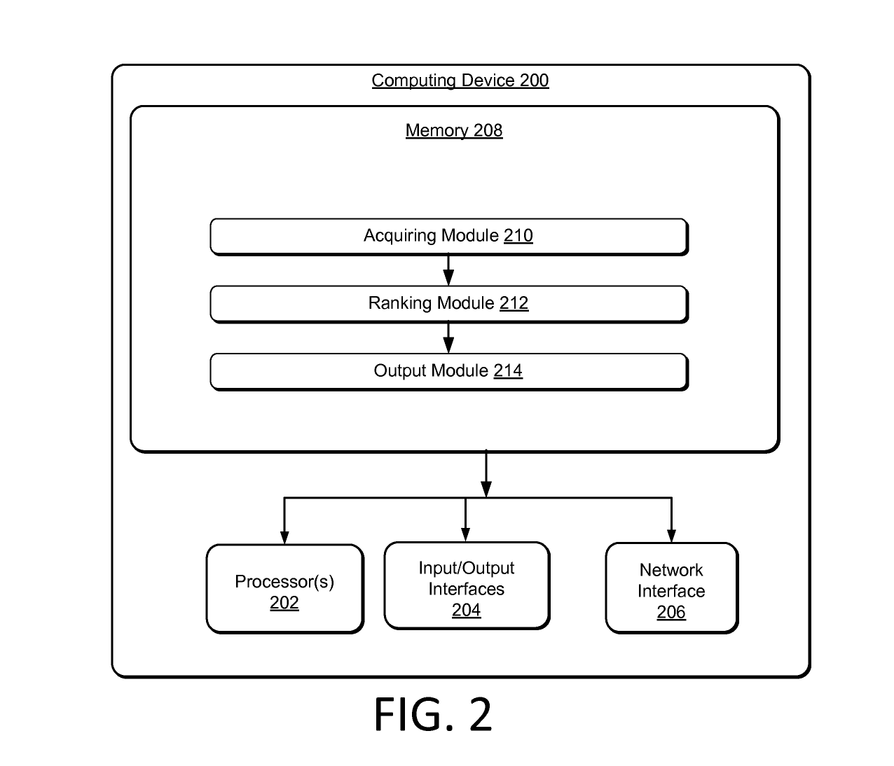

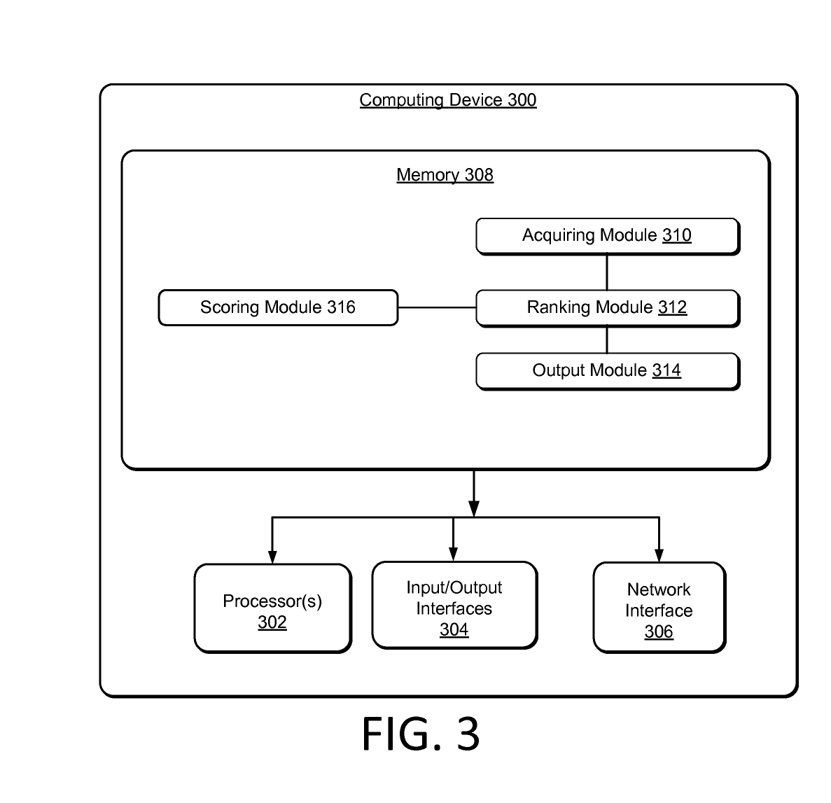

FIGS. 2 and 3 are schematic diagrams of illustrative computing architectures that enable processing sets of objects. In implementations, operations may be performed by the search engine associated with one or more servers. In implementations, operations may be performed by a local client or a network terminal of a distributed system. It is understood that the local client may be a local terminal installed on the terminal or client (nativeApp), or a web browser program (webApp) terminal. The present disclosure is not particularly limited to this as long as the search engine may search sets of objects and/or recommend search results objective.

FIG. 2 is a diagram of a computing device 200. The computing device 200 may be a user device or a server for a multiple location login control. In one exemplary configuration, the computing device 200 includes one or more processors 202, input/output interfaces 204, network interface 206, and memory 208.

The memory 208 may include computer-readable media in the form of volatile memory, such as random-access memory (RAM) and/or non-volatile memory, such as read only memory (ROM) or flash RAM. The memory 208 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 208 in more detail, the memory 208 may include an acquiring module 210, a ranking module 212, and an output module 214.

The acquiring module 210 may acquire at least two sets of objects. In implementations, the acquiring module 210 may search a database based on a keyword in the query entered by the user, and may provide the ranked at least two sets of objects as search results for the user. The current user in the subsequent description of implementations of the present implementations refers to the user.

The acquiring module 210 may search a database based on a keyword in the query entered by the user, and may provide the ranked at least two sets of objects as search results for the user. The acquiring module 210 may acquire at least two sets of objects using various methods.

The ranking module 212 may rank the at least two sets of objects based on an object satisfaction level of a user to an individual set of objects. The object satisfaction level may be obtained based on operation behavioral data on the individual set of objects and operation behavioral data on an object of the individual set of objects.

The output module 214 may provide the ranked at least two sets of objects.

FIG. 3 is a diagram of a computing device 300. The computing device 300 may be a user device or a server for a multiple location login control. In one exemplary configuration, the computing device 300 includes one or more processors 302, input/output interfaces 304, network interface 306, and memory 308.

Similar to the memory 208, the memory 308 may include an acquiring module 310, a ranking module 312, and an output module 314. Further the memory 308 may include a scoring module 316 configured to acquire a first candidate satisfaction level of the user to the individual set of objects based on the operation behavioral data on the individual set of objects.

The scoring module 316 may acquire a second candidate satisfaction level of the user to the individual set of objects based on the operation behavioral data on the object of the individual set of objects and a mapping relationship between multiple sets of objects and multiple objects of the multiple sets of objects. The scoring module 316 may acquire an object satisfaction level based on the first candidate satisfaction level and the second candidate satisfaction level.

In implementations, the operation behavioral data on the set of objects of the user may include operation behavioral data on objects of one or all portions of sets of objects of websites associated with the search engine. In implementations, the operation behavioral data on the set of objects may include operation behavioral data on sets of objects to be ranked. The present disclosure is not particularly limited to this.

In implementations, the operation behavioral data on the set of objects may include search information, browse information, and/or click-through information associated with the user. The present disclosure is not particularly limited to this.

In implementations, the operation behavioral data on an object may include operation behavioral data on objects of one or all portions objects of websites associated with the search engine. In implementations, the operation behavioral data on the object may include operation behavioral data on objects to be ranked. The present disclosure is not particularly limited to this.

In implementations, the operation behavioral data on an object may include searching information, clicking through information, bookmarking information, ordering information, and/or purchasing information associated with the object. The present disclosure is not particularly limited to this.

In implementations, the scoring module 316 may acquire at least one of operation behavioral data on the set of objects, the mapping relationship, or the operation behavioral data on an object from cookie information.

Cookie, sometimes also used the plural form of Cookies, refers to certain data (usually encrypted) used by certain websites to identify or track a user identity and/or a session (Session). The cookie may be stored on a client terminal.

Specifically, these sites may assign a unique identification Cookie (CookieID) for the client terminal to create a Cookie object on the client terminal. Accordingly, operation behavioral data on an object may be stored on the client terminal to form Cookie information. Cookie information may be used to track site statistics, which may indicate habits of users associated with accessing the website. For example, accessing times, visited pages, a time that user spends on the website and an action taken by the user when visiting the website, and so on. A computing device may retrieve the Cookie information using various methods.

When a user first visits the page, the computing device may get a website for the user and assign a unique identification Cookie (CookieID) to the user. The computing device may create a Cookie object on the client terminal. Accordingly, the computing device may store operation behavioral data of the user on the client terminal to form Cookie information. Thus, the client terminal may transmit the Cookie information and specify timing information in the Cookie that is sent to the website. For example, when a client terminal may transmit Cookie to the website when the client terminal requests to revisit the site.

In implementations, the Cookie information may include at least one of CookieID, a user identify of a user, the operation behavioral data on the individual set of objects associated with the user, operation behavioral data on an object of the individual set of objects associated with the user, or a mapping relationship between an object and the set of objects. The present disclosure is not particularly limited to this.

The user identify information may include a user ID or the IP address of the client terminal. The present disclosure is not particularly limited to this.

The mapping relationship between a set of objects and an object of the set of objects, which may include an operation that a user receives a search result of the object and clicks the object. This operation acts may be recorded accordingly.

The scoring module 316 may acquire a first candidate satisfaction level of the user to the individual set of objects based on the operation behavioral data on the individual set of objects, which may include operations the user performs on the individual set of objects of the at least two sets of objects.

In implementations, the operation behavioral data on the set of objects of the user may include operation behavioral data on objects of one or all portions of sets of objects of websites associated with the search engine.

The scoring module may acquire preference feature information of the user to the individual set of objects based on the operation behavioral data on the set of objects. Then, the scoring module may acquire a first candidate satisfaction level of the user to the individual set of objects based on reference feature information of the user to the individual set of objects. In implementations, the scoring module may acquire the first candidate satisfaction level of the user to the individual set of objects based on the mapping between attribute information of the individual set of objects and the preference feature information of the user to the individual set of objects. For example, a successful matching may indicate a high satisfaction level of the user to a set objects, while an unsuccessful matching may indicate a low satisfaction level of the user to the set of object.

A matching algorithm for processing feature information may include various matching algorithms, such as a Euclidean distance algorithm. Use of preference feature information of a set of objects makes the coverage of the set of objects more extensive, effectively improving the accuracy of processing the set of objects.

In implementations, the scoring module may determine at least one object of the individual set of objects based on the mapping relationship, acquire a first candidate satisfaction level of the user to the individual set of objects based on the operation behavioral data on the individual set of objects, which may include operations the user performs on the individual set of objects of the at least two sets of objects, and acquire the second candidate satisfaction level of the individual set of objects based on multiple reference satisfaction levels of the user to objects of the individual set of objects. For example, the scoring module may acquire the second candidate satisfaction level of the individual set of objects based on an average value of multiple reference satisfaction levels of the user to objects of the individual set of objects.

In implementations, the scoring module may determine at least one object of the individual set of objects based on the mapping relationship and then acquire preference feature information of the user to the individual set of objects based on the operation behavioral data on the set of objects, which may include operation data on all the objects of sites associated with the scoring module. The scoring module may acquire the first candidate satisfaction level of the user to the individual set of objects based on attribute information of the individual set of objects and the preference feature information of the user to the individual set of objects, and acquire the second candidate satisfaction level of the individual set of objects based on multiple reference satisfaction levels of the user to objects of the individual set of objects.

A matching algorithm for processing feature information may include various matching algorithms, such as a Euclidean distance algorithm. Use of preference feature information of a set of objects makes the coverage of the set of objects more extensive, therefore, effectively improving the accuracy of processing the set of objects.

In implementations, the scoring module 316 may acquire an object satisfaction level based on the first candidate satisfaction level, a weight factor associated with the first candidate satisfaction level, the second candidate satisfaction level, and a weight factor associated with the second candidate satisfaction level.

The scoring module may obtain the object satisfaction level using the following equation:

$$H ( {s}_{SPUId} ) = ( 1 - α ) [ \frac{{\sum }_{offerId} f ( {x}_{offerId} )}{{N}_{s}} ] + α G ( {s}_{SPUId} )$$

SPUId represents to an ID of a set of objects;

H(s_{SPUId}) represents to the object satisfaction level of the user to a set of objects SPUId,

α represents a weight factor of the first candidate satisfaction level,

G(s_{SPUId}) represents the first candidate satisfaction level,

1−α represents a weight factor of the second candidate satisfaction level,

offerId represents an ID identified an object of the set of objects SPUId,

x_{offerId} represents the operation behavioral data on the identified object offerId of the identified set of objects SPUId,

f(x_{offerId}) represents the reference satisfaction level of the user to the identified object offerId of the identified set of objects SPUId,

Nₛ represents a number of objects of the identified set of objects SPUId,

$$\frac{{\sum }_{offerId} f ( {x}_{offerId} )}{{N}_{s}}$$

represents an average of the second satisfaction levels of the user to each identified object of the identified set of objects SPUId.

In embodiments, the scoring module 316 may rank the at least two sets of objects based on an object satisfaction level of a user to an individual set of objects. The scoring module 316 may rank sets of objects using other techniques. For example, a matching algorithm may be implemented to measure a matching degree between a key word and the set of objects. In these instances, a weight factor may be assigned to an individual ranking parameter. The scoring module 316 may assign the weight factor to the ranking parameter to obtain a ranking fraction and to rank each object.

Multiple items may have a same attribute and may be defined as a SPU, also called a product. Using SPU, a specific item may be located. SPU may be reused. A SPU may correspond to multiple commodities, while a commodity corresponds to only one SPU.

A detailed description may be found in corresponding implementations of FIG. 1. The relevant contents of steps performed by scoring unit may not be mentioned here.

Implementations of the present disclosure may output at least two sets of objects, provide recommendation and guidance to the user, and help the user to fine the object timely. In implementations, the operation behavioral data on an object may be defined based on various needs. For example, the user may need guidance for various operations including ordering, selecting, advertising, and/or purchasing items. In instances, the operation behavioral data on an object may be associated with purchasing information of the object.

In implementations, as for potential users, the operation behavioral data on an object may be associated with storing and/or bookmarking information of the object.

In implementations, if the user needs guidance of website improvement, the operation behavioral data on an object may be associated with click-through information of the object. The present disclosure is not particularly limited to this.

In implementations, the ranking module 212 may rank the at least two sets of objects based on an object satisfaction level of a user to an individual set of objects, and the output module 214 may provide the ranked at least two sets of objects. The object satisfaction level may be obtained based on operation behavioral data on the individual set of objects and operation behavioral data on an object of the individual set of objects. The outputted sets of objects are consistent with historic operation behavior of the user to sets of objects.

In addition, the technical solution provided herein meet the individual needs of users, thereby increasing the accuracy of searches.

In implementations, the object satisfaction level may be obtained based on operation behavioral data on the individual set of objects and operation behavioral data on an object of the individual set of objects associated with the user.

Accordingly, the object satisfaction level may be obtained more than merely the operation behavioral data on the individual set of objects or merely operation behavioral data on an object of the individual set of objects. This may effectively improve the accuracy of processing a set of objects.

The implementations of the present disclosure may acquire the mapping relationship between a set of objections and an object of the set of objects without searching a corresponding object based on an attribute of the set of objects. Therefore, the implementations may effectively avoid extra overhead of searches.

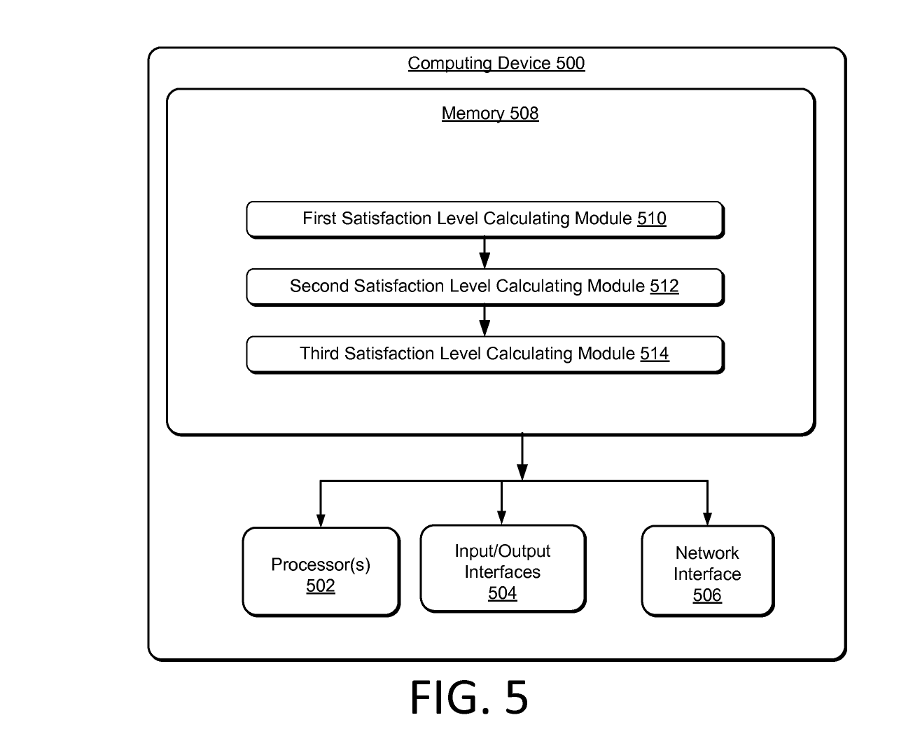

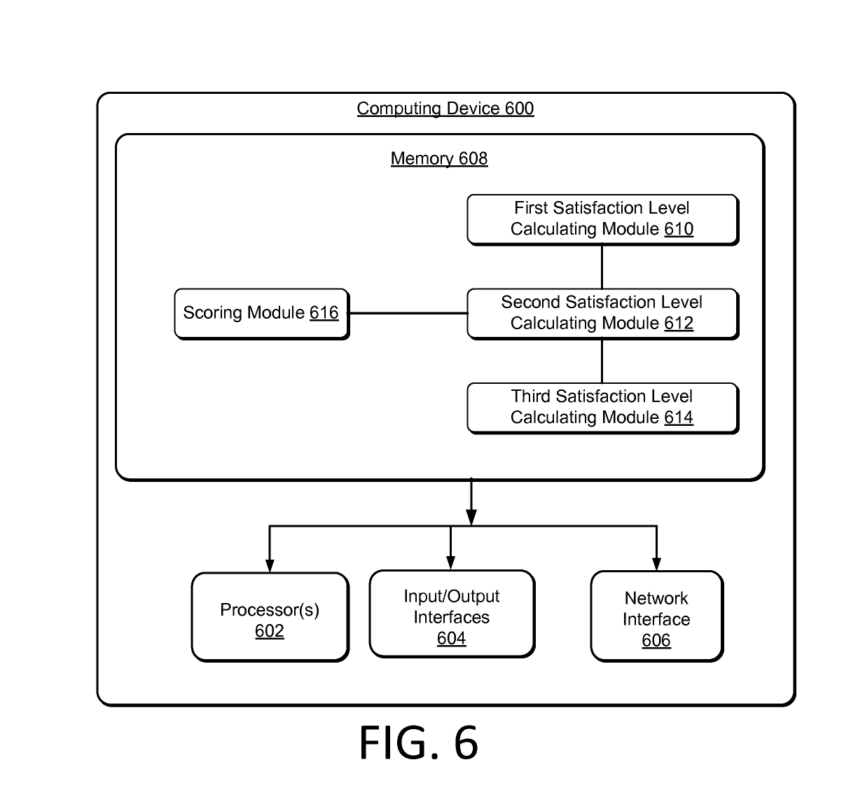

FIGS. 5 and 6 are schematic diagrams of illustrative computing architectures that enable determining satisfaction levels of sets of objects. In implementations, operations may be performed by the search engine associated with one or more servers or a network terminal of a distributed system. It is understood that the local client may be a local terminal installed on the terminal or client (nativeApp), or a web browser program (webApp) terminal. The present disclosure is not particularly limited to this as long as the search engine may search sets of objects and/or recommend search results objective.

FIG. 5 is a diagram of a computing device 500. The computing device 500 may be a user device or a server for a multiple location login control. In an exemplary configuration, the computing device 500 includes one or more processors 502, input/output interfaces 504, network interface 506, and memory 508.

The memory 508 may include computer-readable media in the form of volatile memory, such as random-access memory (RAM) and/or non-volatile memory, such as read only memory (ROM) or flash RAM. The memory 508 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 508 in more detail, the memory 508 may include a first satisfaction level calculating module 510, a second satisfaction level calculating module 512, and a third satisfaction level calculating module 514.

The first satisfaction level calculating module 510 may acquire a first candidate satisfaction level of the user to the individual set of objects based on operation behavioral data on the individual set of objects.

The second satisfaction level calculating module 512 may acquire a second candidate satisfaction level of the user to the individual set of objects based on operation behavioral data on the object of the individual set of objects and a mapping relationship between multiple sets of objects and multiple objects of the multiple sets of objects;

The second satisfaction level calculating module 512 may acquire an object satisfaction level based on the first candidate satisfaction level and the second candidate satisfaction level.

In implementations, the first satisfaction level calculating module 510 may acquire preference feature information of the user to the individual set of objects based on the operation behavioral data on the set of objects, and acquire the first candidate satisfaction level of the user to the individual set of objects based on attribute information of the individual set of objects and the preference feature information of the user to the individual set of objects.

In implementations, the first satisfaction level calculating module 510 may acquire the first candidate satisfaction level of the user to the individual set of objects based on the mapping between attribute information of the individual set of objects and the preference feature information of the user to the individual set of objects. For example, a successful matching may indicate a high satisfaction level of the user to a set objects, while an unsuccessful matching may indicate a low satisfaction level of the user to the set of object.

A matching algorithm for processing feature information may include various matching algorithms, such as a Euclidean distance algorithm. Use of preference feature information of a set of objects makes the coverage of the set of objects more extensive, effectively improving the accuracy of processing the set of objects.

In implementations, the second satisfaction level calculating module 512 may determine at least one object of the individual set of objects based on the mapping relationship, acquire a reference satisfaction level of the user to an individual object of the individual set of objects based on the operation behavioral data on an object, and acquire the second candidate satisfaction level of the individual set of objects based on multiple reference satisfaction levels of the user to objects of the individual set of objects.

FIG. 6 is a diagram of a computing device 600. The computing device 600 may be a user device or a server for a multiple location login control. In an exemplary configuration, the computing device 600 includes one or more processors 602, input/output interfaces 604, network interface 606, and memory 608.

Similar to the memory 508, the memory 608 may include a first satisfaction level calculating module 610, a second satisfaction level calculating module 612, and a third satisfaction level calculating module 614. Further the memory 608 may include a scoring module 616 configured to acquire at least one of operation behavioral data on the set of objects, the mapping relationship, or the operation behavioral data on an object from cookie information.

In implementations, the third satisfaction level calculating module 614 may acquire an object satisfaction level based on the first candidate satisfaction level, a weight factor associated with the first candidate satisfaction level, the second candidate satisfaction level, and a weight factor associated with the second candidate satisfaction level.

For example, the third satisfaction level calculating module 614 may obtain the object satisfaction level using the following equation:

$$H ( {s}_{SPUId} ) = ( 1 - α ) [ \frac{{\sum }_{offerId} f ( {x}_{offerId} )}{{N}_{s}} ] + α G ( {s}_{SPUId} )$$

SPUId represents to an ID of a set of objects;

H(s_{SPUId}) represents to the object satisfaction level of the user to a set of objects SPUId,

α represents a weight factor of the first candidate satisfaction level,

G(s_{SPUId}) represents the first candidate satisfaction level,

α represents a weight factor of the second candidate satisfaction level,

offerId represents an ID identified an object of the set of objects SPUId,

x_{offerId} represents the operation behavioral data on the identified object offerId of the identified set of objects SPUId,

f(x_{offerId}) represents the reference satisfaction level of the user to the identified object offerId of the identified set of objects SPUId,

Nₛ represents a number of objects of the identified set of objects SPUId,

$$\frac{{\sum }_{offerId} f ( {x}_{offerId} )}{{N}_{s}}$$

represents an average of the second satisfaction levels of the user to each identified object of the identified set of objects SPUId.

A detailed description may be found in corresponding implementations of FIG. 1; the relevant contents of steps may not be mentioned here.

In implementations, the object satisfaction level may be obtained based on operation behavioral data on the individual set of objects and operation behavioral data on an object of the individual set of objects.

Accordingly, the object satisfaction level may be obtained more than merely the operation behavioral data on the individual set of objects or merely operation behavioral data on an object of the individual set of objects.

The implementations of the present disclosure may acquire the mapping relationship between a set of objections and an object of the set of objects without searching a corresponding object based on an attribute of the set of objects. This may effectively avoid extra overhead of searches.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method of processing a plurality of sets of objects, the method comprising:
acquiring, by one or more processors of a computing device, the plurality of sets of objects, wherein the plurality of objects are associated with one or more keywords input by a user;
ranking, by the one or more processors, the plurality of sets of objects based on an object satisfaction level of the user to an individual set of objects of the plurality of sets of objects, the object satisfaction level obtained based at least on a first operation behavioral data of the user on the individual set of objects and a second operation behavioral data of the user on an object of the individual set of objects; and
providing, by the one or more processors, the ranked plurality of sets of objects.

2. The method of claim 1, further comprising:
acquiring a first candidate satisfaction level of the user to the individual set of objects based on the first operation behavioral data;
acquiring a second candidate satisfaction level of the user to the individual set of objects based on the second operation behavioral data and a mapping relationship between the plurality of sets of objects and a plurality of objects of the plurality of sets of objects; and
acquiring an object satisfaction level based on the first candidate satisfaction level and the second candidate satisfaction level.

3. The method of claim 2, wherein the acquiring the first candidate satisfaction level comprises:
acquiring preference feature information of the user to the individual set of objects based on the first operation behavioral data; and
acquiring the first candidate satisfaction level of the user to the individual set of objects based on attribute information of the individual set of objects and the preference feature information of the user to the individual set of objects.

4. The method of claim 2, wherein the acquiring the second candidate satisfaction level of the user to the individual set of objects based on the second operation behavioral data and the mapping relationship between the plurality of sets of objects and the plurality of objects of the plurality of sets of objects comprises:
determining at least one object of the individual set of objects based on the mapping relationship;
acquiring a reference satisfaction level of the user to an individual object of the individual set of objects based on the second operation behavioral data; and
acquiring the second candidate satisfaction level of the individual set of objects based on a plurality of reference satisfaction levels of the user to objects of the individual set of objects.

5. The method of claim 2, further comprising:
acquiring at least one of the first operation behavioral data, the mapping relationship, and the second operation behavioral data from cookie.

6. The method of claim 1, wherein the object of the individual set of objects comprises an item, the individual set of objects is a standardized product unit, and the standardized product unit includes a plurality of items that share at least a same attribute value.

7. The method of claim 6, wherein the item is a commodity.

8. A system for processing a plurality of sets of objects:
one or more processors; and
memory to maintain a plurality of components executable by the one or more processors, the plurality of components comprising:
an acquiring module configured to acquire the plurality of sets of objects, wherein the plurality of objects are associated with one or more keywords input by a user;
a ranking module configured to rank the plurality of sets of objects based on an object satisfaction level of the user to an individual set of objects of the plurality of sets of objects, the object satisfaction level obtained based at least on a first operation behavioral data of the user on the individual set of objects and a second operation behavioral data of the user on an object of the individual set of objects, and
an output module configured to provide the ranked plurality of sets of objects.

9. The system of claim 8, wherein the plurality of components further comprise a scoring module configured to:
acquire a first candidate satisfaction level of the user to the individual set of objects based on the first operation behavioral data;
acquire a second candidate satisfaction level of the user to the individual set of objects based on the second operation behavioral data and a mapping relationship between the plurality of sets of objects and a plurality of objects of the plurality of sets of objects; and
acquire an object satisfaction level based on the first candidate satisfaction level and the second candidate satisfaction level.

10. The system of claim 9, wherein the scoring module is configured to further:
acquire preference feature information of the user to the individual set of objects based on the first operation behavioral data; and
acquire the first candidate satisfaction level of the user to the individual set of objects based on attribute information of the individual set of objects and the preference feature information of the user to the individual set of objects.

11. The system of claim 9, wherein the scoring module is configured to further:
determine at least one object of the individual set of objects based on the mapping relationship;
acquire a reference satisfaction level of the user to an individual object of the individual set of objects based on the second operation behavioral data; and
acquire the second candidate satisfaction level of the individual set of objects based on a plurality of reference satisfaction levels of the user to objects of the individual set of objects.

12. The system of claim 9, wherein the scoring module is configured to further acquire at least one of the first operation behavioral data, the mapping relationship, and the second operation behavioral data from cookie.

13. The system of claim 8, wherein the object of the individual set of objects comprises an item, the individual set of objects is a standardized product unit, and the standardized product unit comprises a plurality of items that share at least a same attribute value.

14. The method of claim 13, wherein the item is a commodity.

15. A method for determining satisfaction levels of a plurality of sets of objects, the method comprising:
acquiring, by one or more processor of a computing device, a first candidate satisfaction level of a user to an individual set of objects of the plurality of sets of objects based on operation behavioral data of the user on the individual set of objects;
acquiring, by the one or more processor, a second candidate satisfaction level of the user to the individual set of objects based on operation behavioral data of the user on an object of the individual set of objects and a mapping relationship between the plurality of sets of objects and a plurality of objects of the plurality of sets of objects; and
acquiring, by the one or more processor, an object satisfaction level based on the first candidate satisfaction level and the second candidate satisfaction level.

16. The method of claim 15, wherein the acquiring the first candidate satisfaction level comprises:
acquiring preference feature information of the user to the individual set of objects based on the operation behavioral data of the user on the individual set of objects; and
acquiring the first candidate satisfaction level of the user to the individual set of objects based on attribute information of the individual set of objects and the preference feature information of the user to the individual set of objects.

17. The method of claim 15, wherein the acquiring the second candidate satisfaction level of the user to the individual set of objects based on the operation behavioral data of the user on the object of the individual set of objects and the mapping relationship between the plurality of sets of objects and the plurality of objects of the plurality of sets of objects comprises:
determining at least one object of the individual set of objects based on the mapping relationship;
acquiring a reference satisfaction level of the user to an individual object of the individual set of objects based on the operation behavioral data of the user on an object; and
acquiring the second candidate satisfaction level of the individual set of objects based on a plurality of reference satisfaction levels of the user to objects of the individual set of objects.

18. The method of claim 15, further comprising:
acquiring at least one of operation behavioral data of the user on the set of objects, the mapping relationship, or the operation behavioral data on an object from cookie information.

19. The method of claim 15, wherein the object of the individual set of objects comprises an item, the individual set of objects is a standardized product unit, and the standardized product unit comprises a plurality of items having an attribute value.

20. The method of claim 19, wherein the item is a commodity.
